(19) United States
(12) Patent Application Publication
(10) Pub. No.: US 2013/0124925 A1
(43) Pub. Date: May 16, 2013

(54) METHOD AND APPARATUS FOR CHECKING A MAIN MEMORY OF A PROCESSOR

(71) Applicant: Christian Hildner, Nurnberg (DE)

(72) Inventor: Christian Hildner, Nurnberg (DE)

(73) Assignee: SIEMENS AKTIENGESELLSCHAFT, MUENCHEN (DE)

(21) Appl. No.: 13/810,491

(22) PCT Filed: Jul. 1, 2011
(86) PCT No.: PCT/EP11/61098

§ 371 Date: Jan. 24, 2013

(30) Foreign Application Priority Data
Jul. 16, 2010 (DE) 10 2010 027 287.6

(51) Int. Cl. G06F 11/26

(52) U.S. Cl. CPC G06F 11/26
USPC 714/42

(57) ABSTRACT

A method and an apparatus for checking a main memory of a processor, which includes a cache memory and a plurality of registers. Before the memory test is carried out, a boot-up sequence which may be running at that time is interrupted, temporary data required for the memory test is written to at least one register and is held there, and the access from the cache memory to the main memory is activated. The main memory is accessed via the cache memory such that bit patterns are written to the cache memory and from there to the main memory, and are read out again from the main memory via the cache memory and are compared. The area of the main memory to be tested is larger than the size of the cache memory. The interrupted boot-up sequence is then restarted or continued after completion of the memory test.

The invention relates to a method for checking a main memory of a processor. The invention relates furthermore to an apparatus for checking a main memory of a processor.

In modern computer systems, it is customary for the processor to have a main memory that is as large and as low in cost as possible. For the processing of programs by the processor, various types of memory access such as loading/reading, storing and/or writing of data, operands and/or commands are required.

Based on security and/or operating requirements, it is customary to check parts of the main memory from time to time. Due to the size of the main memory and the relatively long times required by the processor to access the main memory, a memory test takes up a lot of time and runs counter to the demand for short processor boot-up times, for example.

The object underlying the invention is therefore to speed up a method for checking a main memory of a processor. A further object of the invention is to simplify an appliance for checking the main memory.

The object with regard to the method is achieved according to the invention in the features specified in claim 1. With regard to the apparatus, the object is achieved in the features specified in claim 11.

Advantageous embodiments of the invention are the subject matter of the subclaims.

In the method for checking a main memory of a processor, the main memory having a plurality of memory cells, before a memory test is executed, a boot-up sequence which may be running at that time is interrupted and temporary data, such as e.g. program variables, required for the memory test is written to at least one register or is held there. In addition, the access from the cache memory to the main memory is activated, the access to the memory cells of the main memory being executed according to the invention via a cache memory during the memory test such that bit patterns are written to the cache memory and, via this, to the main memory and are read out again from the main memory via the cache memory and are compared, the area of the main memory to be tested being larger than the size of the cache memory. The boot-up sequence which was possibly interrupted before execution of the memory test is then restarted or continued.

After completion of the memory test, the cache memory is then disconnected again from the main memory and the boot-up sequence which was interrupted before execution of the memory test is then restarted or continued. In addition, the bit patterns which are read out again from the main memory are compared with generated target bit patterns. In particular, the memory test is executed before the operating system is started, the boot-up sequence running at that time being the pre-initialization program or the initialization program of a computer program of the processor.

Such a method, using at least one fast cache memory with substantially shorter access times, enables a reliable and, compared with the prior art, significantly faster method of testing the main memory. It is also possible here for the test of the main memory to be executed in stages and/or in blocks.

The processor is preferably embodied as a microprocessor. Microprocessors are processors in which all the components are arranged on a microchip.

It is useful for a pattern comprising zeros and/or ones to be used as a bit pattern for checking the main memory, in particular, word-by-word, cell-by-cell and/or block-by-block. Here, the main memory is, for example, subdivided into areas of uniform size that are independent of one another, e.g. words, blocks (and is thus subdivided word-by-word, block-by-block) which can be read or written at different times. For example, consecutive memory words are written cyclically to consecutive memory banks or blocks and read from these. By testing consecutive memory banks or blocks, the access time can be shortened, since the width of the data bus to the main memory is larger than the word width of the processor.

For reliable long-term operation of the main memory, in a cell-by-cell check, one or more memory cells of the main memory are tested multiple times. Analogously, in a block-by-block test, one or more memory blocks are tested multiple times. A known value and the complement (inversion) of the value are written to each memory cell, such that each bit must hold at one time the value “1” and at another time the value “0”.

In a simple embodiment, one or more memory cells and/or blocks of the main memory are cyclically tested.

Alternatively or additionally, the test can be executed in an event-driven manner. For example, the memory test is executed by the boot loader before the operating system is started. In addition, the main memory test can be activated automatically by the processor after a faulty program run and executed at least once or multiple times.

In a useful embodiment, before a memory test of the main memory is carried out, a test of address and/or data lines is executed. Here, the processor executes the tests of address and/or data lines by accessing the main memory directly and not via the cache memory. The testing of address and/or data lines is thus executed in a conventional manner by direct access before the memory test. Executing the testing of address and/or data lines before a memory test enables identification, in particular, of possible production errors, e.g. line interruptions, short circuits. The memory test for identifying a memory chip error in particular is executed only when the two preceding tests, i.e. the test of the address lines and the test of the data lines, have been completed properly, i.e. error-free.

To prevent data losses, temporary program data or variables are intermediately stored during a memory test, in particular after the testing of address and/or data lines and before the memory test, in a register. After completion of the memory test, this program data or these program variables can be read out again and written to the cache memory and/or main memory. In particular, if the number of registers for the intermediate storage of the temporary data is insufficient, the boot-up sequence is restarted and consequently repeated in order to restore the temporary data. In cases where temporary data discarded during the memory test is no longer needed, the boot-up sequence is continued.

To analyze the memory test that has been executed, the result obtained from comparing the bit patterns is written to a processor register.

In a development of the invention, a plurality of cache memories are used, one of the cache memories being used for storing program code (also referred to as a program or instruction cache) and a further cache memory being used for storing current (i.e. being used at that time) data and/or variables such as program variables and address data, (also referred to as a data cache). The cache memory storing the program code serves at the same time to speed up access to the program code. The data cache, i.e. the cache memory storing the temporary data, serves in particular as storage and to speed up access to the main memory.

The program code, and in particular the program code containing the memory test, is preferably filed in a read-only memory (ROM).

In a development of the invention, the program code containing the memory test is implemented in the main program. This prevents a subroutine call, for which a functional stack memory would be required. Alternatively, the memory test can be implemented as a subroutine. In this case, the program is continued in subroutine calls; a return to the main program is prevented, as program variables from the cache memory may have been lost.

With regard to the appliance for checking the main memory, a cache memory is arranged according to the invention between the main memory and the processor such that during a memory test an access to the memory cells of the main memory can be executed via the cache memory such that predefinable bit patterns can be written to the cache memory, in particular to memory cells thereof and, via this, to the main memory, in particular to memory cells thereof, and can be read out again from these via the cache memory, the processor comparing the bit patterns read out again from the main memory with target bit patterns, the cache memory being otherwise disconnected from the main memory and being available for receiving temporary data, in particular program data, the size of the cache memory being smaller than the area of the main memory to be tested.

The use of a cache memory as a buffer with fast access times makes it possible to speed up memory tests of the main memory. Here, the cache memory can preferably be integrated on the processor chip itself.

Further advantages, features and details of the invention will be described in greater detail below with the aid of exemplary embodiments and with reference to drawings, in which:

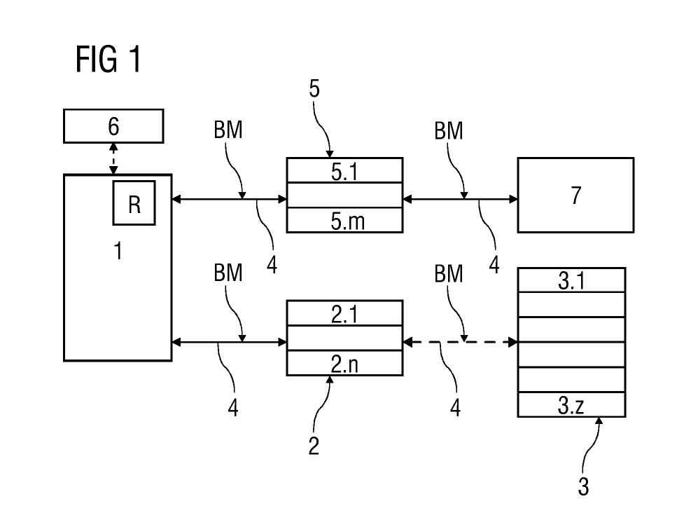

FIG. 1 shows schematically a block diagram of an embodiment of an appliance for checking a main memory, and

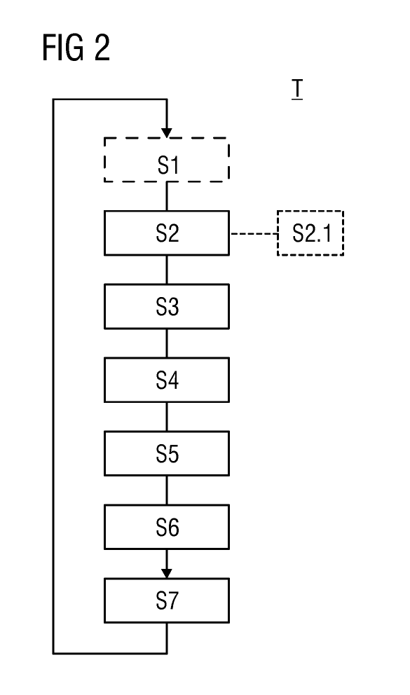

FIG. 2 shows schematically a flow diagram of a memory test for the main memory.

Parts corresponding to one another are labeled with the same reference characters in all the figures.

FIG. 1 shows schematically a block diagram of an embodiment of an appliance for checking a main memory 3 of a processor 1. The processor 1 may be a microprocessor the components of which are arranged on a microchip (not shown in detail).

A cache memory 2 is arranged between the processor 1 and the main memory 3 as an intermediate memory or buffer memory. The processor 1 is connected in a conventional manner via data, address, error and control lines 4 to the cache memory 2, and the latter is connected to the main memory 3.

In order to check the main memory 3, the processor 1 accesses the main memory 3 through the cache memory 2. The main memory 3 is accessed via the cache memory 2 only during the memory test; the cache memory 2 is otherwise disconnected from the main memory 3 (indicated by the dashed line 4).

The main memory 3 is a conventional large working memory of the processor 1. The main memory 3 is accessed, for example, via 8-bit and/or 16-bit address channels or lines. The main memory 3 comprises groups of memory elements which are combined to form a memory cell 3.1 to 3.z (=smallest addressable unit). Each memory cell 3.1 to 3.z comprises 8 bits (=1 byte). A plurality of memory cells 3.1 to 3.z, e.g. 4 or 8 memory calls 3.1 to 3.z can be combined to form a 32-bit and/or 64-bit memory word, a memory block, a memory page and/or a memory bank. This enables the simple addressing of in particular consecutive, uniformly-sized and independent areas of the main memory 3.

The cache memory 2 is a fast intermediate or buffer memory which is arranged between register memories R of the processor 1 and the main memory 3. In the exemplary embodiment shown, the cache memory 2 is arranged outside the processor 1 and consequently not on the processor chip. Alternatively, the cache memory 2 can also be arranged on the processor chip (not shown).

The cache memory 2 has a smaller storage capacity than the main memory 3, for example in the kilobyte or megabyte range, e.g. 1 Mbyte, with very short access times in the nanosecond range, whereas the storage capacity of the main memory 3 lies in the megabyte, gigabyte or terabyte range, e.g. 512 Mbyte, with low access times in the millisecond range.

The cache memory 2 has, like the main memory 3, a plurality of memory cells 2.1 to 2.n, which depending on the predefined settings are combined or segmented correspondingly into words, groups and/or blocks which constitute independent address ranges. The cache memory 2 is for storing currently used data and/or variables, in particular dynamic program variables such as address data.

In addition, the appliance has at least one further cache memory 5 comprising a number of memory cells 5.1 to 5.m. The further cache memory 5 is for storing program code. Here, a read memory 7, e.g. a ROM memory (=read-only memory), in which the program code is stored, is connected downstream of the cache memory 5.

FIG. 2 shows schematically a flow diagram of a memory test T for the main memory 3.

In general, the main memory 3 is checked regularly. A memory test T is preferably executed before the operating system is started.

Compared with conventional test methods, in the method according to the invention, the main memory 3 is accessed not directly from the processor 1 but via the cache memory 2. Here, the access from the processor 1 is executed such that at least one bit pattern BM is written to the cache memory 2 and, via this, to the main memory 3, and is read out again from the latter. The bit pattern BM read out again from the main memory 3 is then compared with a generated target bit pattern. If the two bit patterns are not identical, it can be concluded that there is an error in the main memory 3 or a transmission error.

It is useful for a pattern comprising zeros and/or ones, of a predefined length, e.g. 8-bit, 16-bit, 32-bit length, to be generated as a bit pattern BM. For example, address data is used as a bit pattern BM.

In the checking method, one or more of the memory cells 3.1 to 3.z of the main memory 3 are tested multiple times, in particular cyclically.

In detail, in a first step S1, upon activation of the memory test T and before execution of the memory test T, a test of address lines and/or data lines can optionally be executed in a conventional manner via a direct access and thus without an intermediate memory (shown by a dashed line). In the optional test of the address and/or data lines, specific addresses are tested using generated bit patterns in order to identify production errors, in particular line interruptions and/or short circuits. Only when the previously executed test of the address and/or data lines has been executed error-free is the actual memory test T started and executed.

In step S2, the program code for the memory test T, for example a program test with checking of write and/or read operations, is called. The program code is preferably called in the main program.

Before the processor 1 accesses the cache memory 2 to test the main memory 3, a boot-up sequence running at that time is interrupted.

Optionally or additionally, in a step S2.1, temporary data that is not to be tested but is required for the memory test T, such as e.g. temporary program variables, is intermediately stored in one of the registers 6 and or register memories R. The register memories R are for example currently unused registers of the processor 1. Alternatively, the register memories R and/or further registers 6 may also be arranged outside the processor 1.

In a third step S3, the access to the cache memory 2 for testing the main memory 3 is then activated. This may result in invalid data, in particular temporary program data.

In detail, the test routine implemented in the processor 1, by means of which write and/or read operations to be tested, such as commands and requests, are executed not directly to the main memory 3, but to the cache memory 2, is activated. Here, the test routine is written for example in a machine language (assembly language) or a higher-level programming language using an optimizing compiler in order to hold and store temporary data in registers rather than in the stack in the cache memory 2 or in the main memory 3.

In step S4, the memory test T is then executed according to the implemented test routine. By means of the memory test T, access to the memory cells 2.1 to 2.n of the cache memory 2 concerned is defined and controlled in terms of type, frequency and/or scope. Read or write operations, for example, are defined and controlled as the type of access. The scope is specified, for example, as the number of memory cells 3.1 to 3.m and/or memory blocks of the main memory to be tested.

In detail, in a first loop a number of bit patterns BM corresponding to the size of the area of the main memory 3 to be tested are written to the cache memory 2. Here, the cache memory 2 is smaller than the area of the main memory 3 to be tested, such that, when the memory test T is executed, the cache memory 2 is overwritten with bit patterns BM, and bit patterns BM are written to the area of the main memory 3 to be tested. In a second loop, the bit patterns BM of the area of the main memory 3 to be tested are then read out again via the cache memory 2 and compared with target bit patterns.

For example, bit patterns BM are written block-by-block, word-by-word and/or cell-by-cell to predefined memory cells 2.1 to 2.n of the cache memory 2 and from these to corresponding memory cells 3.1 to 3.z of the main memory 3, and are read out again from this via the cache memory 2 and compared with target bit patterns. The result of the comparison is intermediately stored for example in a predefined further register 6 and/or register memories R of the processor 1.

In step S5, the access to the main memory 3 via the cache memory 2 is then optionally deactivated after termination of the test routine for the memory test T.

In step S6, the stored result of the comparison of the bit patterns BM read out from the main memory 3 with the target bit patterns is checked. The result of the comparison will to this end have been written to the register 6 and/or one of the register memories R of the processor 1 such that this result can be evaluated by an analysis routine implemented in the processor 1.

In step S7, the temporary data intermediately stored in step S3 and optionally in step S2.1 is read out again and the original boot-up sequence of the processor 1 is restarted or initialized, i.e. the boot-up sequence interrupted before execution of the memory test T is restarted or optionally continued.

The memory test T can be started multiple times, for example in a cyclically repeated or event-driven manner. In particular, the memory test T is executed before the operating system is started. Further steps can also be implemented.

The memory test T is implemented in particular as program code or as a test routine in the main program of the processor 1. Alternatively, the program code of the memory test T can be implemented as a subroutine. In this case, subsequent programs are called exclusively as a subroutine, since as a result of the memory test T via the cache memory 2 temporary data, in particular address data in the cache memory 2, may be lost. In order to enable programs to run reliably, all further programs are therefore called as subroutines.

Using the method according to the invention for checking the main memory 3 via the access to the cache memory 2, all memory cells 3.1 to 3.z of the main memory can be individually tested. The memory test T is speeded up significantly through the use of cache memories 2.

1-11. (canceled)

12. A method for checking a main memory of a processor, having a cache memory and a plurality of registers and/or register memories, the method which comprises:
activating an access from the cache memory to the main memory and executing the access to the main memory via the cache memory by writing bit patterns to the cache memory and, from the cache memory, to the main memory, and reading out the bit patterns from the main memory via the cache memory, and comparing the bit patterns;
wherein an area of the main memory to be tested is larger than a size of the cache memory and the memory test is executed cyclically and/or in an event-driven manner; and
writing a known value and a complement of the known value to each memory cell of the main memory such that each bit must hold at one time a value “1” and at another time a value “0”.

13. The method according to claim 12, which comprises, once the memory test has been completed, disconnecting an access of the cache memory to the main memory.

14. The method according to claim 12, which comprises testing address lines and/or data lines before carrying out the memory test, and starting the memory test only after error-free testing of the address lines and/or data lines.

15. The method according to claim 12, which comprises using a bit pattern comprising zeros and/or ones.

16. The method according to claim 12, which comprises, by means of the memory test, testing one or more memory cells of the main memory before starting the operating system.

17. The method according to claim 12, which comprises writing a result obtained from the comparison of the bit patterns to a register of the processor.

18. The method according to claim 12, which comprises using a plurality of cache memories, and using one of the cache memories for storing temporary data such as program variables, and using another cache memory for storing program code.

19. The method according to claim 12, which comprises implementing program code executing the memory test in a main program or in a subroutine with no return option.

20. An apparatus for checking a main memory of a processor, comprising:
a cache memory and a plurality of registers;
at least one cache memory disposed between the main memory and the processor, configured such that, during an execution of a memory test, enabling execution of an access to the main memory via said at least one cache memory such that predefinable bit patterns are written to said cache memory and, through said cache memory to the main memory, and the bit patterns are again read out from the main memory, and wherein the processor is configured to compare the bit patterns read out again from the main memory with target bit patterns;
wherein said at least one cache memory is otherwise disconnected from the main memory; and
wherein a size of said at least one cache memory is smaller than an area of the main memory to be tested.
